(19) United States
(12) Patent Application Publication
(10) Pub. No.: US 2015/0151258 A1
(43) Pub. Date: Jun. 4, 2015

(54) SYSTEM AND METHOD FOR CARBONATING SYRUP BASED CARBONATED DRINKS

(71) Applicant: SodaStream Industries Ltd., Ben Gurion Airport (IL)

(72) Inventors: Avi COHEN, Jerusalem (IL); Guy Danieli, Jerusalem (IL); Eitan Landau, Netanya (IL)

(21) Appl. No.: 14/559,984

(22) Filed: Dec. 4, 2014

Related U.S. Application Data
(60) Provisional application No. 61/911,493, filed on Dec. 4, 2013.

(51) Int. Cl. B01F 3/04

(52) U.S. Cl. CPC B01F 3/04794; B01F 3/04815; B01F 2003/049

(57) ABSTRACT

A carbonation system includes a carbonation head to carbonate a liquid in a bottle and a pressure release unit to steppably release excess pressure from the bottle after carbonation. Another carbonation system operates for multiple types of drinks. It includes a carbonation head to carbonate a drink in a bottle, a controllable valve and a multi-drink controller to control at least the valve to steppably release excess pressure from the bottle after carbonation as a function of the type of drink in the bottle.

### CROSS REFERENCE TO RELATED APPLICATIONS

This application is claims priority from U.S. provisional patent application 61/911,493, filed Dec. 4, 2013, which is incorporated herein by reference.

### FIELD OF THE INVENTION

The present invention relates to soda machines generally.

### BACKGROUND OF THE INVENTION

Soda machines, particularly those which provide a strong level of carbonation into a non-carbonated liquid, release excess pressure before allowing a user to remove the bottle of carbonated liquid from the soda machine. Moreover, such soda machines generally do not allow the user to carbonate any liquid other than water, since syrup-based drinks, in particular, can cause liquid to rise out of the bottle when removed from a soda machine. Moreover, the carbonated drink is sticky and, if the liquid moves into the carbonation system, the sugar in the liquid may stick to elements of the carbonation system causing them to fail.

### SUMMARY OF THE PRESENT INVENTION

There is therefore provided, in accordance with a preferred embodiment of the present invention, a carbonation system including a carbonation head to carbonate a liquid in a bottle and a pressure release unit to steppably release excess pressure from the bottle after carbonation.

There is also provided, in accordance with a preferred embodiment of the present invention, a carbonation system for multiple types of drinks. The system includes a carbonation head to carbonate a drink in a bottle, a controllable valve and a multi-drink controller to control at least the valve to steppably release excess pressure from the bottle after carbonation as a function of the type of drink in the bottle.

Moreover, in accordance with a preferred embodiment of the present invention, the pressure release unit includes an orifice, a controllable valve to control gas input to said orifice, and a controller to open and close the controllable valve.

Further, in accordance with a preferred embodiment of the present invention, the pressure release unit includes a stepped relief valve.

Alternatively, in accordance with a preferred embodiment of the present invention, the pressure release unit includes a pinch valve, a flexible pipe and a controller to open and close the pinch valve on the flexible pipe.

Further, in accordance with a preferred embodiment of the present invention, the carbonation head includes a pressure regulator to reduce the pressure of an incoming gas to an operating pressure, a gas activator to control the passage of the reduced pressure gas and a pressure transducer to control the gas activator based on a pressure level in the bottle during carbonation.

Still further, in accordance with a preferred embodiment of the present invention, the carbonation system also includes a stirrer.

Moreover, in accordance with a preferred embodiment of the present invention, the stirrer is rotatable in both a clockwise and a counter-clockwise direction.

Additionally, in accordance with a preferred embodiment of the present invention, the pinch valve, flexible pipe and stirrer are formed into a single head.

Further, in accordance with a preferred embodiment of the present invention, the single head is removable from the carbonation system.

Still further, in accordance with a preferred embodiment of the present invention, the single head is designed to operate for one of: a group of drinks, a type of bottle and a bottle volume.

Moreover, in accordance with a preferred embodiment of the present invention, controller has multiple schedules for opening and closing the pinch valve, where each schedule is associated with a particular single head.

Further, in accordance with a preferred embodiment of the present invention, the pressure release unit includes a froth sensor to sense a frothing of the liquid in the bottle after carbonation.

Still further, in accordance with a preferred embodiment of the present invention, the froth sensor is an optical sensor set to view said bottle above a water line of said bottle.

Alternatively, in accordance with a preferred embodiment of the present invention, the froth sensor includes two metal disks formed on a plastic carbonation tube of the carbonation head with a portion of the carbonation tube therebetween.

Moreover, in accordance with a preferred embodiment of the present invention, the carbonation system also includes a burst disk safety valve.

Finally, in accordance with a preferred embodiment of the present invention, the carbonation system also includes a unit to steppably provide a fixed amount of gas to the carbonation head.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a carbonation system, constructed and operative in accordance with a first preferred embodiment of the present invention;

FIG. 2 is a schematic illustration of a froth sensor built within a carbonation tube, forming part of the system of FIG. 1;

FIG. 3 is a graphical illustration of the state of a controllable valve with respect to time, useful in understanding the system of FIG. 1;

FIG. 4 is a graphical illustration showing the pressure in the bottle over time;

FIG. 5 is a schematic illustration of a carbonation system, constructed and operative in accordance with a second preferred embodiment of the present invention;

FIG. 6 is a schematic illustration of an alternative carbonation system to that illustrated in FIG. 1, constructed and operative in accordance with a third preferred embodiment of the present invention;

FIGS. 7A and 7B are schematic illustrations of a stepped relief valve used in the carbonation system of FIG. 6;

FIG. 8 is a schematic illustration of an alternative carbonation system, constructed and operative in accordance with a fourth preferred embodiment of the present invention; and

FIGS. 9A, 9B, 9C and 9D are schematic illustrations of elements of the system of FIG. 8.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that syrup-based drinks froth during the release of pressure to atmospheric pressure and that the froth can be reduced by a controlled release of pressure from a bottle of carbonated drink. Moreover, Applicants have realized that such a controlled release of pressure may be achieved with a controlled valve, an orifice to control the flow and a controller to control the opening and closing of the valve in relation to the orifice size and the pressure. Further, Applicants have realized that the controlled release may help to keep the carbonation elements clean.

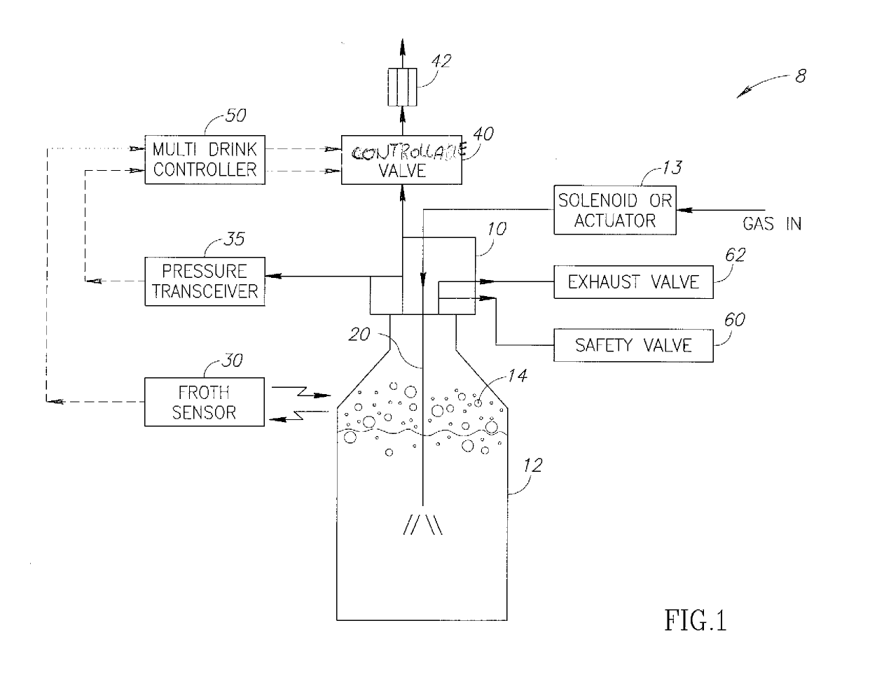

Reference is now made to FIG. 1, which illustrates a carbonation system 8, constructed and operative in accordance with a first preferred embodiment of the present invention. Carbonation system 8 may comprise a carbonation head 10 to which a bottle 12 may be attached, a gas actuator 13 to release gas to carbonation head 10, a carbonation tube 20 to provide CO₂ gas into bottle 12, a froth sensor 30 to sense froth 14 within bottle 12, a pressure transducer 35 to sense the pressure in bottle 12, a controllable valve 40 to controllably release gas from bottle 12 through an orifice 42 and a multi-drink controller 50 to control valve 40. Carbonation system 8 may additionally comprise at least one safety valve 60 and an exhaust value 62 to release excess pressure, if necessary. Controller 50, which may be operated by software of an appropriate kind, may control the operation of carbonation system 8. In particular, controller 50 may indicate to gas solenoid or actuator 13 to begin and end carbonation. The carbonation may be to any desired carbonation level and controller 50 may enable a fixed amount of CO₂ gas to pass according to predetermined time. Controller 50 may activate froth sensor 30 once carbonation has finished and excess pressure is ready to be released from bottle 12. Controller 50 may open and close controllable valve 40 to release gas from bottle 12 through orifice 42 as a function of the output of froth sensor 30. Controller 50 may operate to ensure that the level of frothing measured by froth sensor 30 does not exceed a predetermined frothing level so as to keep the frothing within bottle 12.

Froth sensor 30 may be any suitable sensor which may indicate the presence of frothing within bottle 12. For example, froth sensor 30 may be an optical sensor, set to view the inside of bottle 12, above the water line. Thus, optical froth sensor 30 will provide a signal when frothing rises above the desired line or above a maximum allowable level within bottle 12. Optical froth sensor 30 may be an IR (infrared) sensor whose intensity is a function of the reflection off the bottle, which may have one level of reflection when there is gas in bottle 12 and another when there is froth in bottle 12.

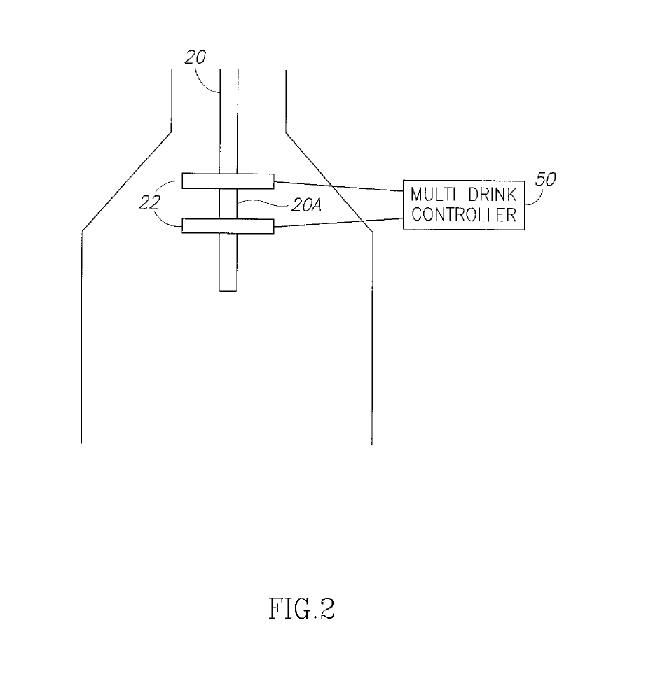

In an alternative embodiment, shown in FIG. 2 to which reference is now briefly made, froth sensor 30 may be built as part of the carbonation tube 20. In this embodiment, carbonation tube 20 may be formed of three sections of plastic divided by two metal disks 22, which disks 22 may be electrically connected to controller 50. In effect, disks 22, with portion 20A of carbonation tube 20 there between, may form a dielectric which changes the resistance between discs 22 in the presence of liquid. When there is air between disks 22, the dielectric may have a high resistance and thus may provide an open circuit to controller 50 while, when there is liquid between disks 22, such as in the presence of froth, there may be current flow from one disk 22 to another.

Disks 22 may be placed such that the upper disk may mark a maximum allowable height of liquid within bottle 12.

As mentioned hereinabove, controller 50 may operate to ensure that the level of frothing measured by froth sensor 30 does not exceed a predetermined frothing level so as to keep the frothing within bottle 12. To do so, controller 50 may open controllable valve 40, to release gas through orifice 42, until the frothing level reaches the predetermined frothing level, at which point, controller 50 may close controllable valve 40. Controller 50 may wait a predetermined amount of time or may wait until froth sensor 30 may indicate that the frothing level was reduced below a predefined sensor level.

After the waiting period is over or upon receipt of an indication from froth sensor 30, controller 50 may reopen controllable valve 40, keeping valve 40 open again until controller 50 receives an indication from froth sensor 30, at which point controller 50 may again close controllable valve 40. Controller 50 may repeat the process until pressure transducer 35 may indicate the presence of atmospheric pressure in bottle 12. This may provide an additional safety mechanism to ensure that bottle 12 only be removed when it is safe to do so.

It will be appreciated that carbonation system 8 may keep frothing within bottle 12 at a low level and thus, may keep the elements of carbonation system 8 clean from sticky liquid. Moreover, by controlling the frothing, carbonation system 8 may reduce the likelihood of drink rising out of the bottle upon releasing the pressure in bottle 12.

It will further be appreciated that, by controlling the frothing, carbonation system 8 may operate for many different types of drinks, where each type of drink may have different sugar levels and different amounts of frothing.

The carbonation system of FIG. 1 may be considered a ‘closed loop’ system. In an alternative embodiment, carbonation system 8 may operate in an open loop manner, without froth sensor 30. In this embodiment, controller 50 may have a multiplicity of preset schedules, one schedule per group of drink, for opening and closing controllable valve 40, based on expected frothing levels and frothing patterns for that group of drink.

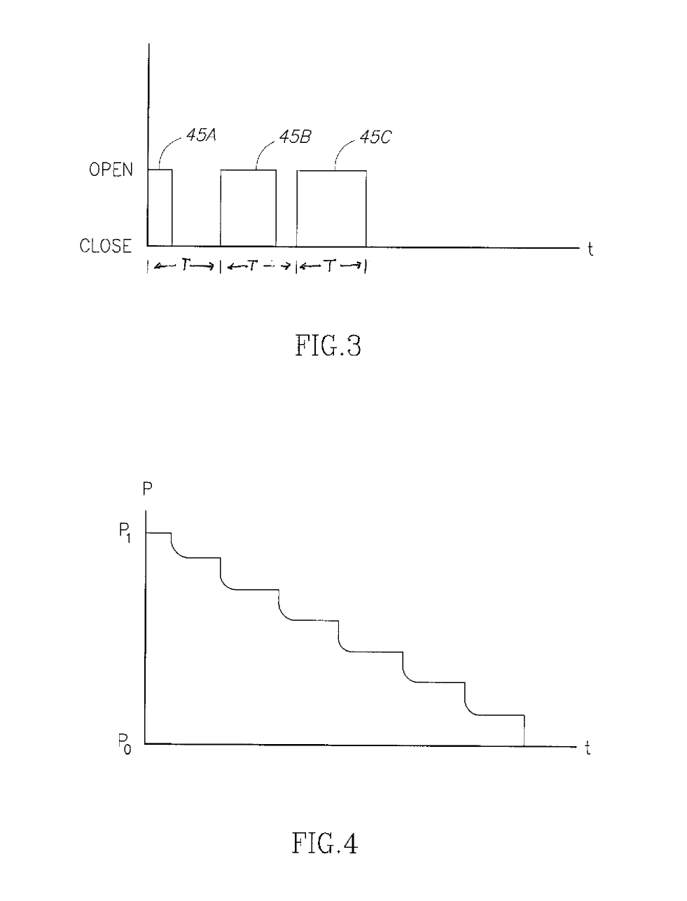

Alternatively, controller 50 may always open controllable valve 40 for the same length of time, but a different number of times per drink group. Further alternatively and as shown in FIG. 3, to which reference is now made and which graphs the state of valve 40 with respect to time, controller 50 may increase the length of time within a cycle time T that controllable valve 40 may be open, starting with a short period of time 45A and gradually increasing its length (shown as 45B and 45C).

It will be appreciated that controller 50 may control the frequency and length of time that valve 40 may be opened and closed. This may be a form of “pulse width modulation” whereby the width of the pulse (the time that the valve is open) may be controlled.

It will be appreciated that in the previous embodiments, the pressure in bottle 12 may be gradually “stepped down” from the high pressure level required to carbonate the liquid down to atmospheric pressure. This is shown in FIG. 4, to which reference is now briefly made. FIG. 4 shows the pressure in bottle 12 over time, where the initial pressure P₁ is the initial pressure in bottle 12 after carbonation and the final pressure P₀ is atmospheric pressure. As can be seen, the pressure decreases in steps rather than all at once.

It will be appreciated that controllable valve 40 and orifice 42 may together provide a controllable bleeding valve. Valve 40 may be any suitable electronically controlled valve and orifice 42 may be any suitable orifice and may have a fixed opening. The amount of flow Q through an orifice is a function of the shape C of the orifice and the pressure differential ΔP across the orifice (Q=CΔP). Thus, for a given pressure difference across the orifice, there is a known amount of gas flowing through for a given amount of time. Controller 50 may close valve 40 during carbonation and may open and close it, as discussed hereinabove, to controllably release the pressure in bottle 12.

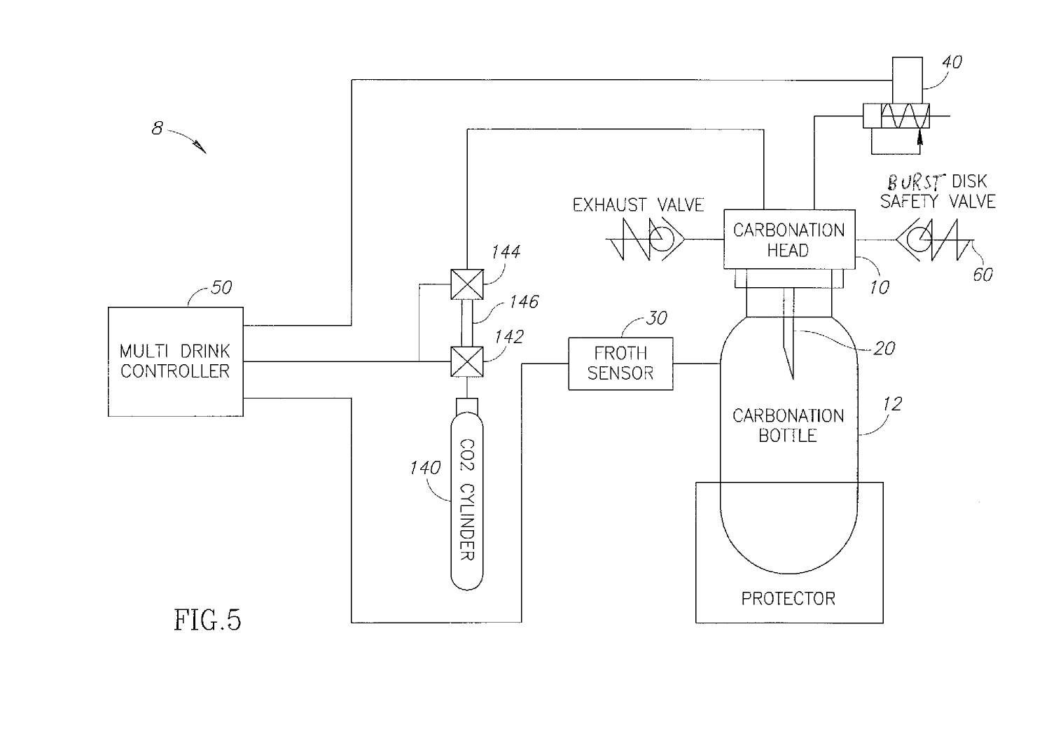

Reference is now made to FIG. 5, which illustrates a further alternative embodiment of the system of FIG. 1 controlling the amount of CO₂ gas being provided during carbonation. Similar reference numerals refer to similar elements.

FIG. 5 shows the elements of FIG. 1 along with a CO₂ canister 140 and two solenoid actuated valves 142 and 144 controlled by controller 50. Controller 50 may activate valves 142 and 144 alternatively such that, at any one time, only one of them is open. Thus, when valve 142 controlling the output of CO₂ canister is open, gas can move into a tube 146 between valves 142 and 144 but cannot move any further since valve 144 is closed. Once controller 50 may close valve 142, controller 50 may open valve 144, thereby enabling the gas in tube 146 to move towards carbonation head 10. Since tube 146 is of a fixed size, the amount of CO₂ provided to carbonation head 10 at any one time may be a fixed amount.

It will be appreciated that in this embodiment, controller 50 may control the amount of CO₂ to carbonation head 10, thereby to control the amount of carbonation as a function of the type of drink to be carbonated.

It will be appreciated that there is always a possibility that, despite all precautions, some drink liquid, which is generally sticky, may get into the workings of carbonation system 8 and may keep the system from being able to release pressure as planned. Accordingly, the system of FIG. 5 may include an additional safety valve 60 as an extra measure for when the standard safety and exhaust valves, which may be part of the standard carbonation system, may fail due to this stickiness.

Safety valve 60 may be a burst disk protected safety valve, such as is described in patent applications 61/864,660 filed 12 Aug. 2013 and 61/911,500 filed 4 Dec. 2013, both entitled “Burst Disk Protected Valve”, both assigned to the common assignees of the present invention. Safety valve 60 may be set to open at a fixed pressure, such as 10 bars, thereby to enable any excess pressure in bottle 12 to escape that, for whatever reason, cannot be released by controllable valve 40 or exhaust valve 62. It is possible that safety valve 60 may also become clogged and may fail to operate accordingly. Therefore, safety valve 60 may comprise a burst disk which may burst at a pressure above the fixed pressure; for example, it may be set to burst at 15 bars. Safety valve 60 may thus enable pressure to be released before the pressure in bottle 12 exceeds its maximum allowable pressure, such as 17 bars.

Valve 62 may be any suitable exhaust valve set to the carbonation pressure (for example 8 bars) which may open during the carbonation process when pressure rises above the pre-set carbonation pressure (for example 8 bars). It may be a normally open or normally closed type of exhaust valve.

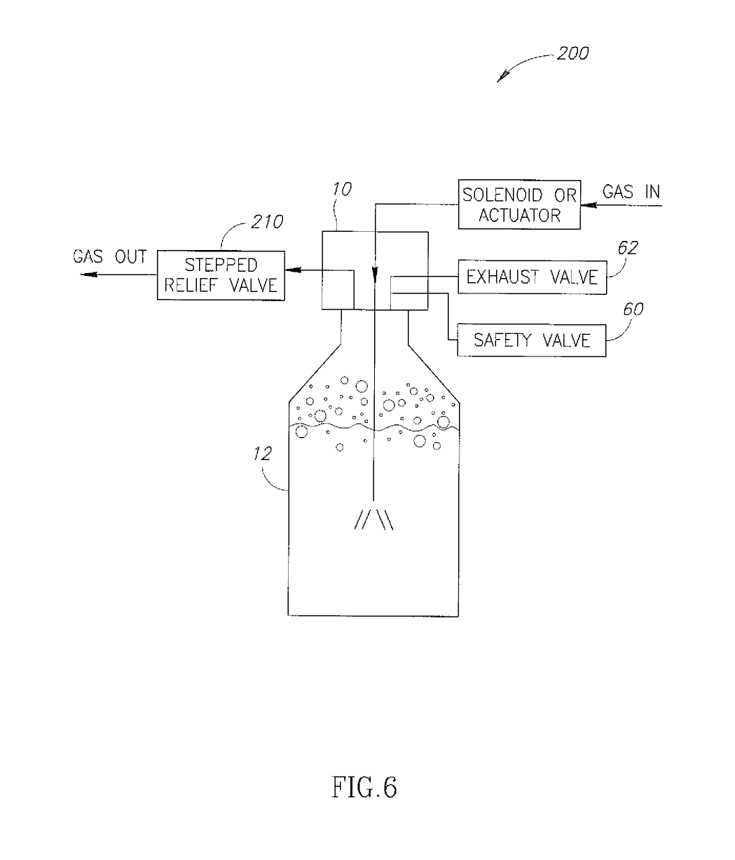

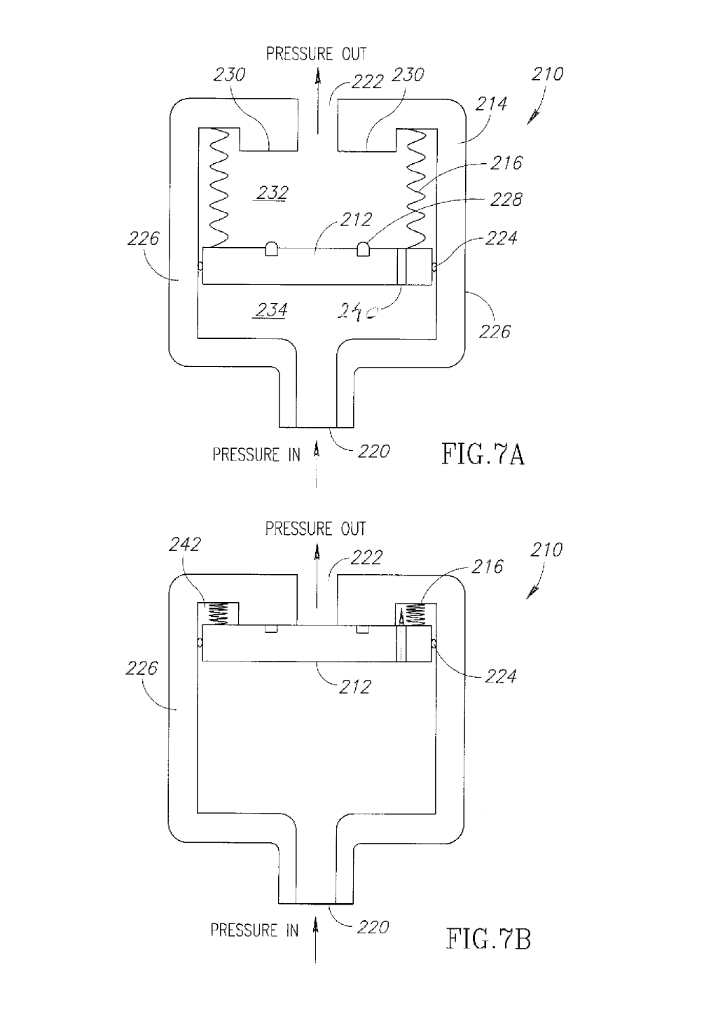

Reference is now made to FIG. 6, which illustrates an alternative carbonation system, labeled 200, which may control the release of pressure via a stepped relief valve 210, and to FIGS. 7A and 7B which illustrate two states of stepped relief valve 210.

Since stepped relief valve 210 may controllably release the pressure in bottle 12 through mechanical means, system 200 may not include multi-drink controller 50, froth sensor 30 or pressure transducer 35 of system 8 (FIG. 1). Instead, system 200 may comprise carbonation head 10, stepped relief valve 210, safety valve 60 and exhaust valve 62.

As shown in FIG. 7A, stepped relief valve 210 may comprise a plate 212 which may move within a housing 214 against the action of a spring 216. Housing 214 may have an inlet 220 and an outlet 222. Valve 210 may also comprise a first O-ring 224 to seal between plate 212 and side walls 226 of housing 214 and a second O-ring 228 to seal between plate 212 and protrusions 230 of housing 214 surrounding outlet 222.

It will be appreciated that plate 212, together with O-ring 224, may divide the space within housing 214 into two sections, an upper section 232 and a lower section 234. However, the division is incomplete since there may be a small orifice 240, of a small diameter, to allow gas to bleed from lower section 234 to upper section 232.

In operation, when the pressure in bottle 12 increases, such as may happen upon the release of carbon dioxide, the pressure of bottle 12 may push against plate 212. If the pressure is sufficient to overcome the force of spring 216, plate 212 may move towards protrusions 230, pushing gas out of upper section 232. If the pressure is great enough, it may push plate 212 against protrusions 230, sealing upper section 232 closed and reducing it to a small, sealed area around outlet 222, labeled 242 in FIG. 7B.

Plate 212 may not be able to move any more, but, due to orifice 240, gas may still bleed into area 242 of upper section 232. Since area 242 may be sealed, pressure may build up in area 242 due to the bleeding of the gas from lower section 234. Eventually, the pressure difference between area 242 and section 234 may be small enough to allow spring 216 to push plate 212 back towards inlet 220, thereby enabling gas again to escape from upper section 232 through outlet 222.

The escaping gas may cause the pressure in upper section 232 to drop, thereby enabling the upward pressure against plate 212 to push plate 212 once again against protrusions 230 and the process may repeat itself.

It will be appreciated that, when plate 212 is moving up or down within housing 214, bottle 12 may be open to the atmosphere and frothing may occur. However, whenever plate 212 may be pushed against protrusions 230, bottle 12 may effectively be sealed (since the leakage through orifice 240 may be small). This may stop the pressure drop in bottle 12, thereby reducing the amount of froth therein until plate 212 begins to move again.

It will be appreciated that stepped relief valve 210 may effectively slowly reduce the pressure in bottle 12 until the pressure within bottle 12 approaches atmospheric pressure, at which point, bottle 12 may be safely removed from carbonation system 200.

It will also be appreciated that stepped relief valve 210 may provide a stepped pressure drop, where the pressure may stop dropping each time plate 212 is pushed against protrusions 230, enabling the froth to be reabsorbed.

As discussed hereinabove, different drinks create different amounts of froth and thus, need to be stepped differently. The speed of stepping for valve 210 is a function of the width of orifice 240. Either system 200 may have exchangeable valves, one per type of drink, or the width of orifice 240 may be as narrow as necessary for the frothiest drink.

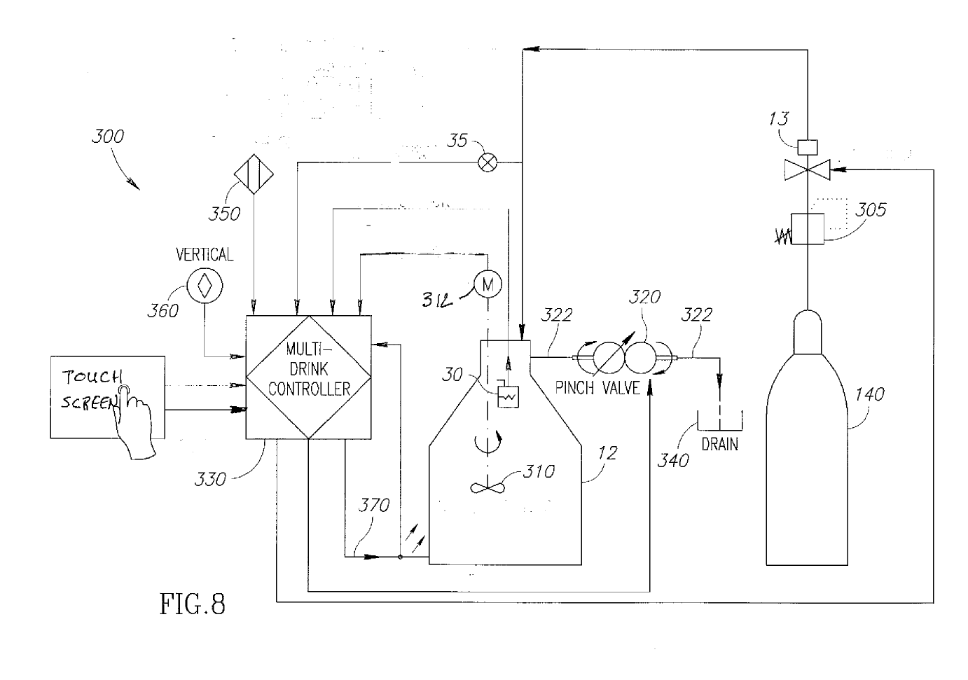

Reference is now made to FIG. 8, which illustrates a further alternative embodiment of the carbonation system of the present invention, labelled 300, which does not utilize carbonation head 10 nor safety valves 60 or 62. Instead, carbonation system 300 may comprise a pressure regulator 305 to control the output of CO₂ cylinder 140 and to reduce it to a desired working pressure, such as 8 bars. Carbonation system 300 may additionally comprise pressure transducer 35 to sense the pressure in bottle 12, gas solenoid or actuator 13 to control the gas coming from CO₂ cylinder 140 in response to the output of pressure transducer 35, a stirrer 310 to cause turbulence in the liquid in bottle 12 to enable the liquid to absorb the incoming CO₂ gas and a pinch valve 320 to pinch a flexible outlet pipe 322, such as a silicon pipe or any type of rubber tubing, thereby to control the froth. Stirrer 310 may be controlled by a stirrer motor 312.

Typically, carbonation system 300 may comprise a multi-drink controller, here labeled 330, which may control the elements of carbonation system 300. For example, upon instructions from the user of the type of drink to be made, multi-drink controller 330 may activate gas actuator 13 to pass the gas, at 8 bars, into bottle 12 and may activate stirrer motor 312 to cause stirrer 310 to stir the liquid in bottle 12 at the same time. Multi-drink controller 330 may monitor the pressure output of pressure transducer 35 and may deactivate gas actuator 13 when the pressure in bottle 12 may approach and/or exceed 8 bars. Multi-drink controller 330 may enable stirrer 310 to continue to operate, thereby reducing the gas pressure in bottle 12, due to the absorption of gas into the liquid. When the gas pressure has reduced to below a pre-determined value, such as 7.5 bar, multi-drink controller 330 may reactivate gas actuator 13. Alternatively, actuator 13 may remain open during carbonation and transducer 35 may monitor for low pressure due to an empty cylinder or other reasons.

This process may continue for a pre-determined period of time, at which point, the liquid in bottle 12 may have achieved a desired carbonation level, such as a predetermined level or a level chosen by the user, such as high, medium or low. For example, the carbonation level may vary between 3 grams per liter to 10 grams per liter.

When the carbonation process has finished, multi-drink controller 330 may begin releasing gas through flexible outlet pipe 322 but may control the release via pinch valve 320.

Pinch valve 320 may be wrapped around flexible outlet pipe 322 and may squeeze pipe 322, thereby reducing the open cross area of pipe 322, until pipe 322 is completely closed, thereby reducing the amount of gas released therethrough. Pinch valve 320 may typically be controlled by a servomotor which may receive instructions from multi-drink controller 330. Multi-drink controller 330 may open and close pinch valve 320 according to a schedule, which may be dependent on the type of drink being made in bottle 12, where frothier drinks may require pinch valve 320 to be closed, or made smaller, for longer periods of time.

In accordance with one embodiment of this invention, stirrer motor 312 may be operated to alternatively turn stirrer 310 in the clockwise and then counter-clockwise directions. Applicants have realized that this may provide stronger carbonation in a shorter period of time.

Since it is possible that some drink may pass through the pinch valve, carbonation system 300 may also include a drain 340. Carbonation system 300 may also comprise a tilt sensor 350, a vertical sensor 360 and a bottle size detector 370, to ensure that bottle 12 may be placed correctly before starting the carbonation process. Carbonation system 300 may also comprise froth sensor 30, if desired.

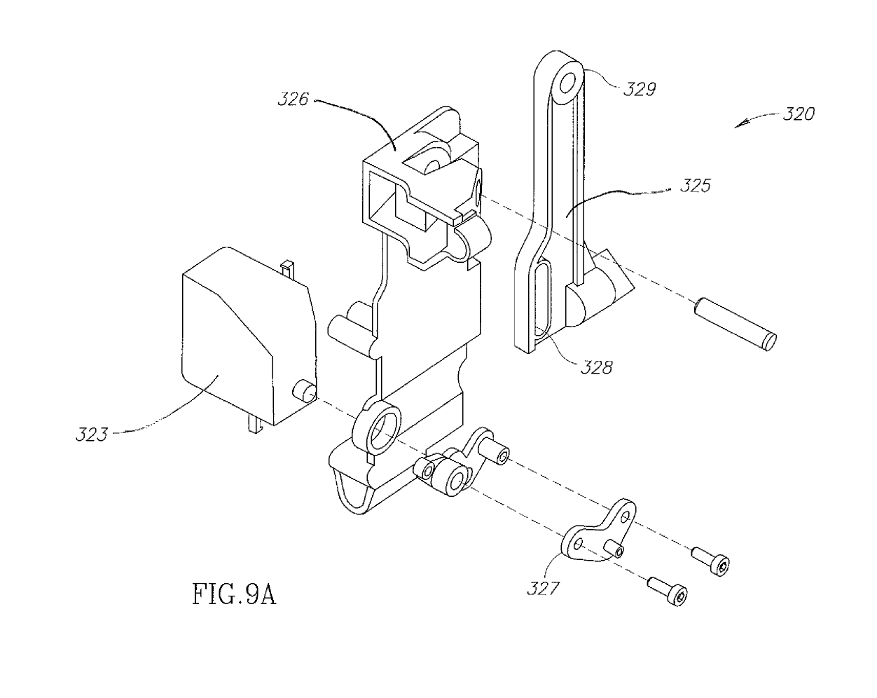

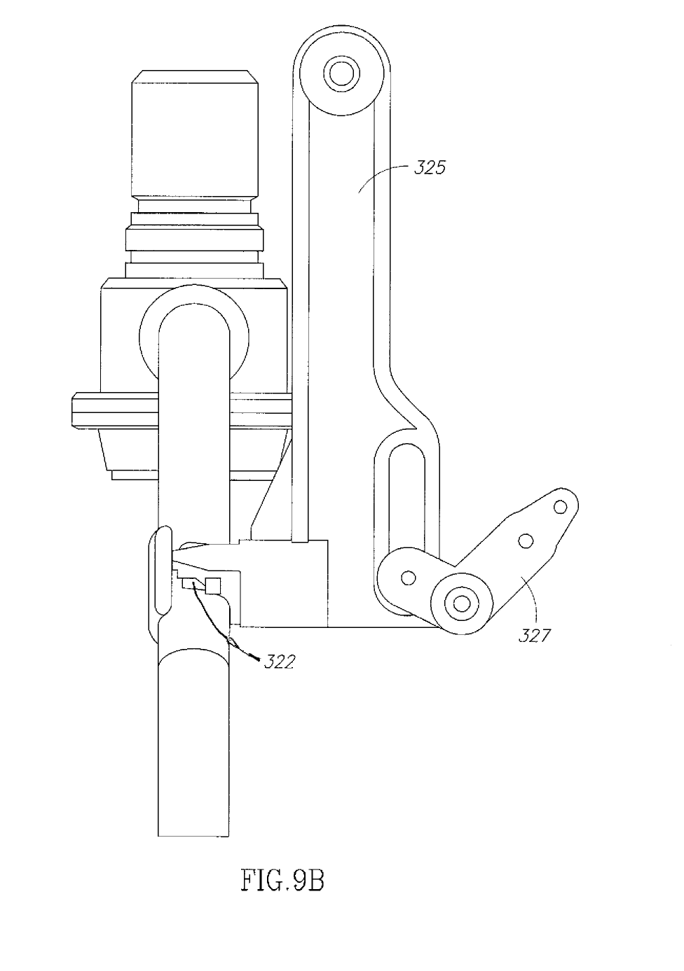

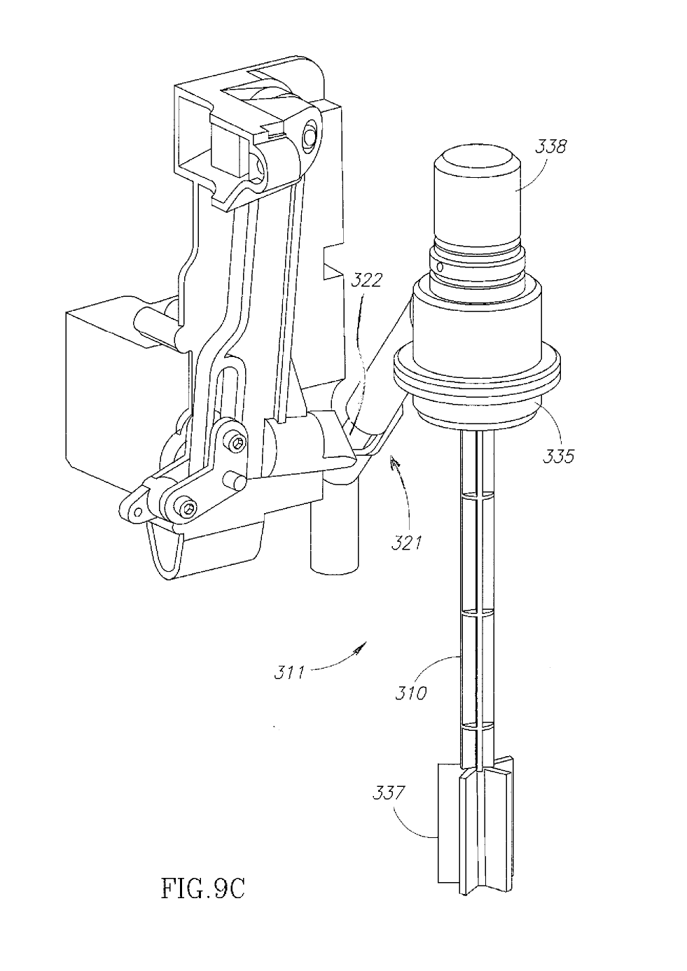

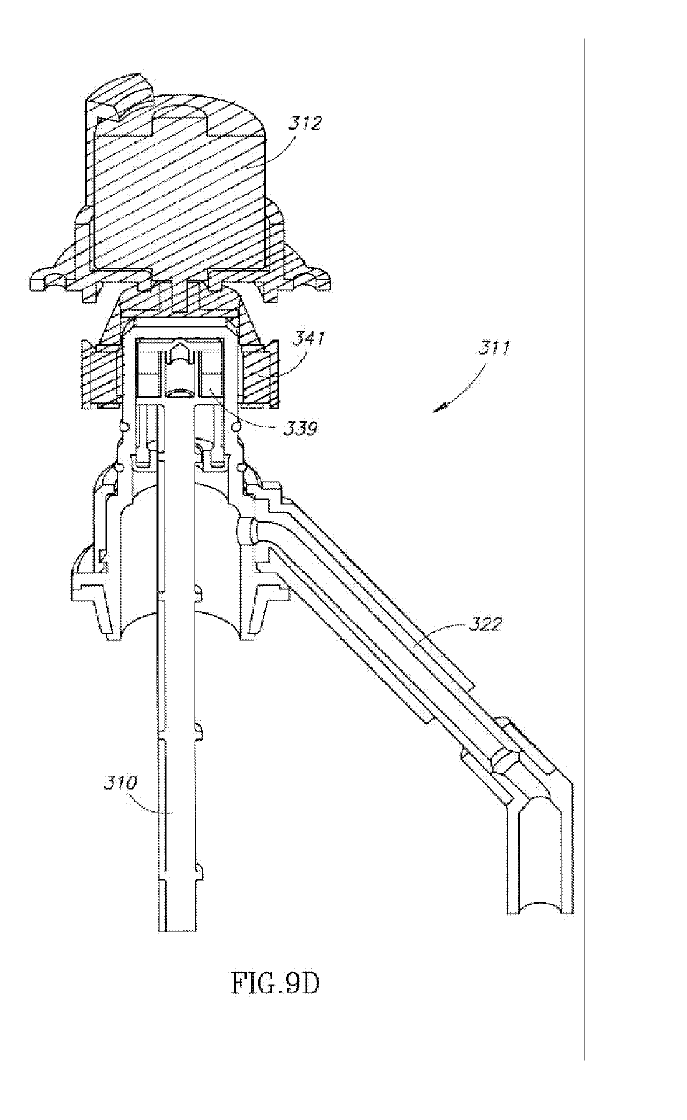

Reference is now made to FIGS. 9A, 9B, 9C and 9D, which, together, illustrates pinch valve 320, stirrer 310 and outlet pipe 322. FIG. 9A shows the elements of pinch valve 320 in an expanded view. Pinch valve 320 may comprise a servo motor 323, a hammer 325, a housing 326 and a cam 327. Hammer 325 may have a slit 328 in which cam 327 may slide when rotated by servo motor 323. This sliding motion may cause hammer 325 to rotate about its pivot point 329.

As shown in FIG. 9B, the rocking of cam 327 may cause hammer 325 to rock, causing hammer 325 to push flexible pipe 322 at a pinching point 321.

FIG. 9C shows pinch valve 320 together with stirrer 310 and outlet pipe 322 connected thereto. As shown in FIG. 9C, stirrer 310 and outlet pipe 322 may be formed into a single head 311, which may sit on bottle 12 and may seal it, with a seal 335. Seal 335 may be an O-ring or any suitable ring-shaped seal and may be attached to a housing 336 which may also house stirrer 310. Stirrer 310 may extend generally through the center of the ring and into bottle 12. Stirrer 310 may have an impeller 337 at an end thereof which may have any suitable shape to effect turbulence.

As shown in FIG. 9D, outlet pipe 322 may extend from housing 336 and may be connected to the open areas of the unit, thereby to provide an outlet for the gas collecting in bottle 12. As can be seen in FIG. 9D, stirrer 310 may comprise magnets 339 to couple stirrer 310 to the housing of carbonation system 300, which may also have magnets, labeled 341, thereby to provide magnetic coupling between stirrer 310 and stirrer motor 312. Thus, head 311 may be disconnectable from carbonation system 300. This may enable a user to easily clean the unit.

If desired, multiple heads 311 may be produced, for different types of drinks, for different groups of drinks, for different bottle shapes or for different bottle volumes. Typically the grouping ensures that the elements therein have similar frothing properties. Each head 311 may have a different size outlet pipe 322 where the smaller outlet pipes may be suitable for the frothier drinks.

Each head 311 may have a label of some kind, which may be read by a suitable reader, thereby to indicate to multi-drink controller 330 the type of drinks to be made and the appropriate schedule for releasing gas.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A carbonation system comprising:
a carbonation head to carbonate a liquid in a bottle; and
means to steppably release excess pressure from said bottle after carbonation.

2. The carbonation system according to claim 1 and wherein said means comprises:
an orifice;
a controllable valve controlling the gas output to said orifice; and
a controller to open and close said controllable valve.

3. The carbonation system according to claim 1 and wherein said means comprises a stepped relief valve.

4. The carbonation system according to claim 1 and wherein said means comprises:
a pinch valve;
a flexible pipe; and
a controller to open and close said pinch valve onto said flexible pipe.

5. The carbonation system according to claim 4 and wherein said carbonation head comprises a pressure regulator to reduce the pressure of an incoming gas to an operating pressure, a gas activator to control the passage of said reduced pressure gas and a pressure transducer to control said gas activator based on a pressure level in said bottle during carbonation.

6. The carbonation system according to claim 5 and also comprising a stirrer.

7. The carbonation system according to claim 6 and wherein said stirrer is rotatable in both a clockwise and a counter-clockwise direction.

8. The carbonation system according to claim 6 and wherein said pinch valve, flexible pipe and stirrer are formed into a single head.

9. The carbonation system according to claim 8 and wherein said single head is removable from said carbonation system.

10. The carbonation system according to claim 8 and wherein said single head is designed to operate for one of: a group of drinks, a type of bottle and a bottle volume.

11. The carbonation system according to claim 10 and wherein said controller has multiple schedules for opening and closing said pinch valve, each schedule associated with said single head.

12. The carbonation system according to claim 1 and wherein said means comprises:
a froth sensor to sense a frothing of said liquid in said bottle after carbonation.

13. The carbonation system according to claim 12 and wherein said froth sensor is an optical sensor set to view said bottle above a water line of said bottle.

14. The carbonation system according to claim 12 and wherein said froth sensor comprises two metal disks formed on a plastic carbonation tube of said carbonation head with a portion of said carbonation tube therebetween.

15. The carbonation system according to claim 12 and also comprising a burst disk safety valve.

16. A carbonation system for multiple types of drinks, the system comprising:
a carbonation head to carbonate a drink in a bottle;
a controllable valve; and
a multi-drink controller to control at least said valve to steppably release excess pressure from said bottle after carbonation as a function of the type of drink in said bottle.

17. The carbonation system according to claim 16 and also comprising means for steppably providing a fixed amount of gas to said carbonation head.

18. The carbonation system according to claim 16 and also comprising a flexible outlet pipe, wherein said controllable valve is a pinch valve to pinch said flexible outlet pipe.

19. The carbonation system according to claim 18 and wherein said carbonation head comprises a pressure regulator to reduce the pressure of an incoming gas to an operating pressure, a gas activator to control the passage of said reduced pressure gas and a pressure transducer to control said gas activator based on a pressure level in said bottle during carbonation.

20. The carbonation system according to claim 19 and also comprising a stirrer.

21. The carbonation system according to claim 20 and wherein said stirrer is rotatable in both a clockwise and a counter-clockwise direction.

22. The carbonation system according to claim 20 and wherein said pinch valve, flexible pipe and stirrer are formed into a single head.

23. The carbonation system according to claim 22 and wherein said single head is removable from said carbonation system.

24. The carbonation system according to claim 22 and wherein said single head is designed to operate for one of: a group of drinks, a type of bottle and a bottle volume.

25. The carbonation system according to claim 24 and wherein said controller has multiple schedules for opening and closing said pinch valve, each schedule associated with said single head.

26. The carbonation system according to claim 16 and also comprising:
a froth sensor connected to said multi-drink controller to sense a frothing of said liquid in said bottle after carbonation.

27. The carbonation system according to claim 26 and wherein said froth sensor is an optical sensor set to view said bottle above a water line of said bottle.

28. The carbonation system according to claim 26 and wherein said froth sensor two metal disks formed on a plastic carbonation tube of said carbonation head with a portion of said carbonation tube therebetween.

29. The carbonation system according to claim 16 and wherein said means comprises:
an orifice;
a controllable valve controlling the gas output to said orifice; and
a controller to open and close said controllable valve.

30. The carbonation system according to claim 16 and wherein said means comprises a stepped relief valve.

31. The carbonation system according to claim 16 and also comprising a burst disk safety valve.
